(19) United States
(12) Patent Application Publication
(10) Pub. No.: US 2016/0182935 A1
(43) Pub. Date: Jun. 23, 2016

(54) METHOD TO CONTROL THE RENDERING OF A MEDIA CONTENT UPON DETECTION OF A PHONE CALL

(71) Applicant: Orange, Paris (FR)

(72) Inventors: Jerome Augui, Meudon (FR); Frederic Mit, Paris (FR)

(21) Appl. No.: 14/973,125

(22) Filed: Dec. 17, 2015

(30) Foreign Application Priority Data
Dec. 17, 2014 (FR) 1462633

(51) Int. Cl. H04N 21/41; H04M 3/42; H04N 21/436; H04N 21/643; H04N 21/6587; H04N 21/647; H04N 21/439; H04N 21/472; H04W 4/00; H04N 21/426

(52) U.S. Cl. CPC H04N 21/4126; H04W 4/008; H04M 3/42; H04N 21/43615; H04N 21/42607; H04N 21/6587; H04N 21/64753; H04N 21/4394; H04N 21/47217; H04N 21/64322

(57) ABSTRACT

A method of controlling playback by a TV decoder module of a media stream on at least one device connected to the TV decoder. The method is performed by a home gateway connected to the TV decoder and a telephone control module. The telephone control module controls at least one telephone handset, wherein, in the event of the telephone control module receiving a telephone call, the home gateway determines whether there is proximity between the telephone handset and a device connected to the TV decoder, and if there is proximity, sends a first message to the TV decoder, the first message including an instruction to record the media stream being played back.

### TECHNICAL FIELD TO WHICH THE INVENTION RELATES

The present invention relates in general manner to the field of audio-visual equipment. More particularly, the invention relates to a method of controlling how a module of the TV decoder type plays back a media stream on at least one device that is connected to the TV decoder.

### TECHNOLOGICAL BACKGROUND

Home audio-visual equipment installations, typically constituted by electronic equipment installed at home such as TV sets or hi-fi equipment, is nowadays becoming more and more connected, whether to the Internet or locally. We have gone from a period when a home-installed TV set was connected to a single external antenna socket and operated in entirely autonomous manner, to a period in which a TV set is nowadays often connected to intermediate equipment such as a TV decoder (also known as a set-top box (STB)), that is generally provided by an Internet access supplier. The TV set thus serves only to display a media stream coming from that intermediate equipment. The media streams then also generally come from a home gateway connected to the Internet.

Interconnecting various pieces of home equipment makes it possible to propose innovative services to users and to make their life easier. One example of such a service is given in patent application US 2008/0134278. That document describes a solution in which the presence of a mobile telephone beside a TV decoder enables those pieces of equipment to interact, in particular when the TV decoder is disseminating content on a TV set. When the TV decoder detects the presence of the telephone in its close environment, and when an incoming call is received by the telephone, the decoder can then respond by displaying information to the effect that an incoming call is being received directly on the TV set to which it is connected. If a user of the system accepts the incoming call on the telephone, then the TV decoder can pause the content being played. The TV set can also be used for playing back the voice of the caller during the call.

It can thus be seen that interactions are possible between interconnected pieces of equipment. Nevertheless, the above-described system suffers from certain drawbacks. For example, detecting that the telephone and the TV decoder are close to each other may require the use of a base dedicated to the telephone, or the presence of a Bluetooth module in the telephone. It is therefore necessary to use a new piece of hardware (the base) or technology (Bluetooth) that is not generally present in a so-called “fixed” telephone. Furthermore, the system described is not well adapted when a called user is watching content in the company of other people, since those other people can no longer benefit from the broadcast content if the call is accepted.

### SUMMARY OF THE INVENTION

The invention proposes remedying the above-described drawbacks by proposing a method of controlling the playback by a TV decoder module of a media stream on at least one device connected to the TV decoder, the method being performed by computer means including a piece of user equipment connected to the TV decoder and including a telephone control module, which telephone control module controls at least one telephone handset, wherein, in the event of the telephone control module receiving a telephone call, the user equipment determines whether there is proximity between the telephone handset and a device connected to the TV decoder, and if there is proximity, sends a first message to the TV decoder, the first message including an instruction to record the media stream being played back.

Thus, when several users are viewing or listening to a media stream, and a telephone call is received while the handset is in the proximity of the media stream playback device, i.e. typically a TV set, the TV decoder can record the media stream throughout the duration of the call. The users then have the option of returning to the media stream being disseminated from the moment corresponding to the arrival of the call, i.e. from the beginning of viewing or listening being disturbed. The method may be performed by a home gateway, or set-top box, that may possibly be included in the same piece of equipment as the TV decoder. The method may more generally be performed by any piece of user equipment such as mobile equipment or a tablet controlling a fixed telephone handset.

In an additional implementation of the present invention, the first message is sent when a user accepts the telephone call.

Advantageously, recording of the media stream is not started unless the call is accepted by a user. This avoids any need to start recording the media stream every time a new call arrives even if the new call is rejected or ignored. When a call is ignored or rejected, the disturbance is minor and the user experience of viewing or listening remains unchanged.

In an additional implementation of the present invention, the first message includes an instruction to control the sound volume of the media stream played back on at least one connected device.

Advantageously, at the same time as recording of the media stream is started, the sound volume of the media stream being played back is reduced in order to avoid disturbing the telephone conversation with the called user, while still allowing other users to continue to follow the media stream during that time.

In an additional implementation of the present invention, the determination of proximity between the telephone handset and the device connected to the TV decoder comprises the following steps: receiving a first audio signal picked up by a microphone of the telephone handset; receiving a second audio signal, the second audio signal corresponding to an audio signal associated with the media stream played back on at least one device; and determining whether there is correspondence between the first and second audio signals, with correspondence indicating that there is proximity.

This solution thus enables the microphone of the telephone handset to be used for picking up ambient sound around the handset, which sound corresponds to the first audio signal. This ambient sound is then compared with the sound corresponding to the media stream. In other words, if it is possible to hear the sound corresponding to the media stream via the telephone handset, it can be deduced that the telephone handset is in the proximity of the playback device, i.e. typically the TV set. This method thus provides a good guarantee of proximity being detected reliably, unlike methods relying on pieces of equipment detecting one another by using radio technologies such as Bluetooth. Such methods can easily find that there is proximity even though the handset and the playback device are in different rooms, since radio waves pass more easily through obstacles such as walls. This also means that the method described in the present document can be triggered only when appropriate. There is thus no need to use this method if the TV decoder is on and receiving a media stream but some other media stream coming from some other source is being disseminated on the playback device. This can happen, for example, if the TV decoder is on but the users are watching a DVD by using some other reader, or more simply watching television by using a receiver that is internal to the TV set.

In an additional implementation of the present invention, the first or second audio signal is an audio stream.

Advantageously, the audio signal picked up by the handset is picked up continuously and the corresponding audio stream is sent to the home gateway. Likewise, and advantageously, the audio signal associated with the media stream being played back on at least one device is sent continuously to the TV decoder. One or the other or both of these possibilities may advantageously be used. Using continuous audio streams makes it possible continuously to detect whether there is proximity.

In an alternative implementation of the present invention, reception of the second audio signal comprises the following steps: sending a request to the TV decoder to send a second audio signal, the second audio signal corresponding to an audio signal associated with the media stream being played back on at least one device; and receiving in response to the request at least one second message comprising the second audio signal.

Advantageously, the home gateway sends a request to the TV decoder for it to send the audio signal corresponding to the media stream being broadcast. Thus, on request, the TV decoder can provide the audio signal corresponding to the broadcast media stream being played back by a device, such as a TV set, thus enabling the gateway to use this audio signal in order to determine whether there is proximity between the TV set and the telephone handset.

In an additional implementation of the present invention, the method further includes a subsequent step when the telephone call ends: sending a third message to the TV decoder, the third message including an instruction to present a predefined user interface on a playback device, the user interface comprising a first user-selectable option of stopping the recording of the media stream, and a second user-selectable option of playing back the recorded media stream, with recording of the media stream continuing.

Advantageously, when the call comes to an end, the user is given the option via a graphics interface displayed on a playback device connected to the TV decoder, such as the TV set, either to continue viewing or listening to the stream being broadcast live, or else to go back to the moment of interruption by the incoming call, with this being made possible by recording being started at that moment. In other words, at the end of the call, the user can choose between continuing to view live without interruption or to switch to a deferred viewing mode, restarting from the moment the telephone call arrived.

In an additional implementation of the present invention, the fourth message includes an instruction to control the sound volume of the media stream being played back on the connected device.

Advantageously, when the telephone call comes to an end, the sound volume of the media stream being played back on the connected device is restored to be identical to the volume it had before the telephone call arrived.

The present invention also provides a home gateway connected to a TV decoder, the TV decoder playing back a media stream on at least one device that is connected thereto, the home gateway including a telephone control module, which telephone control module controls at least one telephone handset, said home gateway is adapted to determine whether there is proximity between the telephone handset and a device connected to the TV decoder, and to control playback and recording of the media stream by the TV decoder as a function of whether proximity is determined.

The present invention also provides a computer program for performing steps of the method of controlling the playback by a TV decoder module of a media stream on at least one device connected to the TV decoder, the program being performed by computer means including a home gateway connected to the TV decoder when the program is executed by at least one processor of the home gateway.

Furthermore, the computer program of the invention may use any programming language, and be in the form of source code, object code, or code intermediate between source code and object code, such as in a partially compiled form, or in any other desirable form.

Consequently, the invention also provides a computer readable data medium including instructions of a computer program of the invention. Such a data medium may be constituted by any entity or device capable of storing such a program. For example, the medium may comprise storage means, such as a memory of read only memory (ROM) type, e.g. a compact disk (CD) ROM, or a microelectronic circuit ROM, or indeed removable recording means such as a USB stick or magnetic recording means, such as a hard disk. Furthermore, a software module or program of the invention may in particular be downloaded from an Internet type network, e.g. via a server or a set of dedicated servers. The advantages provided by a computer program, as briefly defined above, are identical to or contribute to the advantages mentioned above with reference to the method of controlling the playback by a TV decoder module of a media stream, which method is performed by computer means including a home gateway connected to the TV decoder, and those advantages are not repeated here.

### DESCRIPTION OF THE FIGURES

FIG. 1 shows a home gateway suitable for performing the method in accordance with an implementation of the invention.

FIGS. 2A and 2B show systems in accordance with two embodiments of the invention.

FIG. 3 is a flow chart showing the invention being performed in an implementation of the invention.

### DETAILED DESCRIPTION

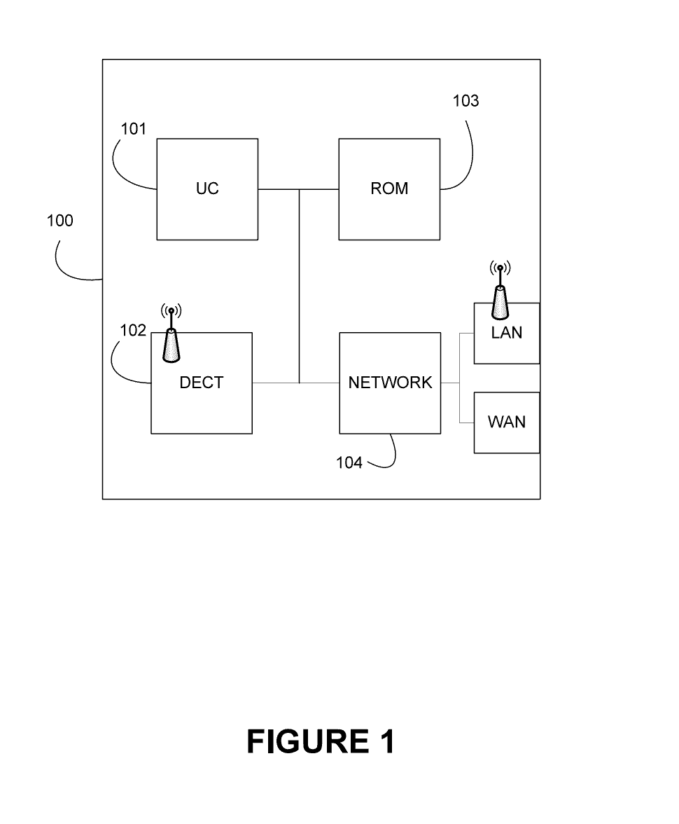

FIG. 1 shows a home gateway 100 suitable for performing the method in accordance with an implementation of the invention.

Such a home gateway 100, sometimes referred merely as a “box”, is made available to users or subscribers by an Internet access provider (IAP). The home gateway is a piece of network terminating equipment that the Internet access provider makes available to subscribers. The gateway enables subscribers to benefit from broadband Internet access (e.g. using access technologies of the xDSL, optical fiber, cable, 4G, . . . type), and also enables subscribers to benefit, by way of example, from services of the “triple play” type, i.e. a bundle of services that are other than Internet access proper (Internet protocol (IP) telephony and IP TV), together with functions that are additional to those of a conventional modem (router or switch, connections to client pieces of equipment by WiFi, DLNA service, etc.). Thus, a home gateway often serves to receive media streams, as supplied by the Internet access provider. These media streams correspond to services of the IP television type, and also services of the video on demand (VOD) type. These services can be provided by the Internet access provider or by some other provider, with the media streams transiting via the home gateway. Such services may also include radio by Internet or music streaming services (such as Deezer™, Spotify™, Qobuz™, . . . ).

The home gateway 100 described below has the particular feature of including a telephone control module 102, in this example specifically a DECT controller complying with the cordless advanced technology-Internet and quality (CAT-iq) standard. It can be understood that this telephone control module 102 could in certain embodiments be separate from the home gateway 100, with it being possible for the home gateway to control the module 102 remotely, e.g. via a wired or IP connection. This DECT model 102 is suitable for associating—or “pairing”—with one or more telephone handsets, which handsets are then controlled by the DECT module 102. It is then possible to receive telephone calls using those telephone handsets. The telephone line associated with the DECT control module 102 is often a voice over IP (VoIP) line provided by the Internet access provider, but there is no reason why the VoIP line might not be provided by some other service provider, or indeed why a conventional public switched telephone network (PSTN) line might not be used if the home gateway is connected to the PSTN. This may apply in particular when the Internet access provider provides Internet access by means of xDSL technology.

The home gateway 100 may comprise a central unit module 101, a memory module 103, and a network module 104. The network module 104 typically provides a wide area network (WAN) connection corresponding to accessing the network of the Internet access provider, and thus provides access to the Internet. The network module also provides at least the possibility of a local area network (LAN) connection enabling pieces of client equipment to be connected. Such connection typically takes place either via an Ethernet connection or via a WiFi module incorporated in the network module 104. The pieces of equipment connected to a home gateway generally include a TV decoder, which TV decoder can receive and process media streams transmitted via the home gateway 100. Media stream “processing” should be understood, by way of example, as selecting and possibly demultiplexing or decoding from among all potential media streams those media streams that are to be played back via at least one device connected to the TV decoder.

A device connected to the TV decoder typically comprises a TV set. However other devices may be connected thereto, either in addition to or instead of the TV set, such as for example a video projector, a hi-fi system or a sound bar, i.e. so-called active or amplified loudspeakers. Devices may be connected to the TV decoder by any wired or wireless means, such as for example a cable in compliance with the high definition multimedia interface (HDMI) standard. Thus, the media streams played back by the TV decoder via at least one device may be played back via one or more devices depending on the nature of the streams. Typically, the TV decoder may be connected to a TV set and to a sound bar, the TV set receiving the audio and video components of the media stream, while the sound bar receives only the audio component.

The connection between the home gateway and the TV decoder is generally made via an IP data connection, either using Ethernet or WiFi, however it is also possible for there to be a direct connection between these two pieces of equipment, which connection may be wired or provided by a direct WiFi link, for example.

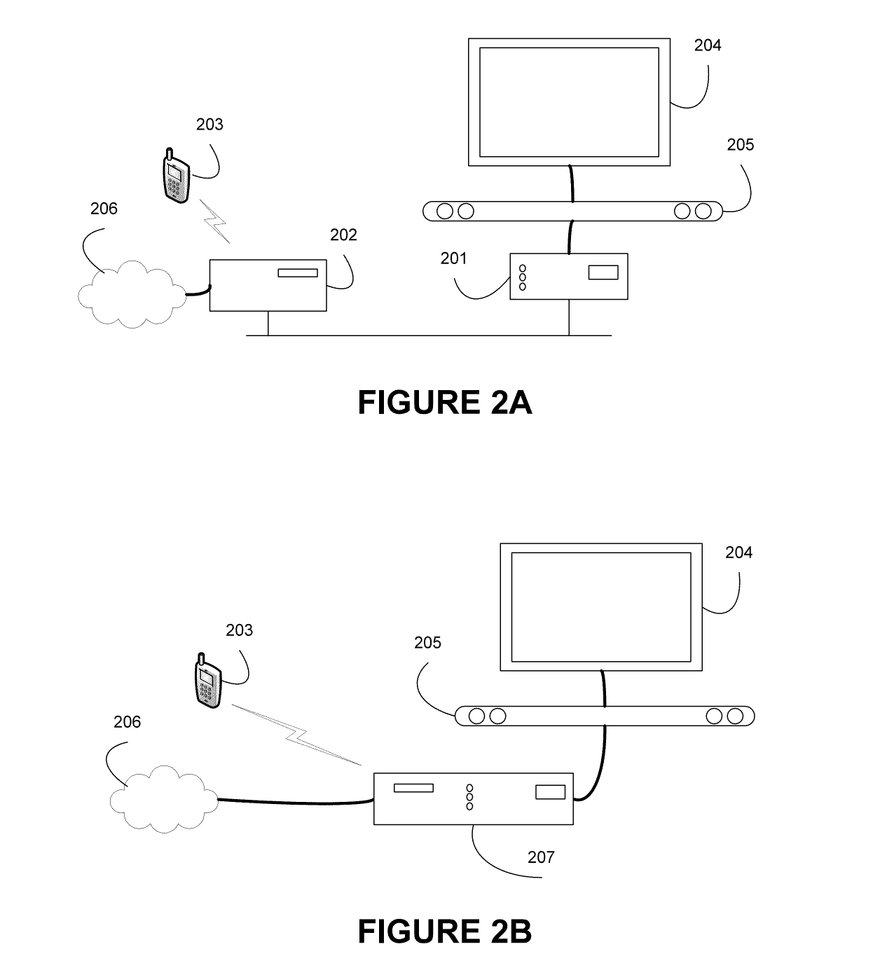

FIGS. 2A and 2B illustrate systems in accordance with two embodiments of the invention.

FIG. 2A shows a system in accordance with the embodiment already described with reference to FIG. 1, i.e. a system made up of a home gateway 100, here represented by a piece of equipment 202, and a TV decoder 201. These two pieces of equipment, the home gateway 100, 202, and the TV decoder 201, are thus two distinct pieces of equipment that are connected together in this example via an Ethernet network. In this example, the home gateway 100, 202 is connected to the Internet 206 via technology that is not shown, but that may be of the xDSL, optical fiber, cable, 4G, WiMax, or other type.

The TV decoder 201 is connected to a sound bar 205 and to a TV set 204. In this example, the connection of the TV set 204 to the TV decoder 201 is shown as passing via the sound bar 205, which is provided with an HDMI input and an HDMI output. The sound bar 205 may be used for playing back the sound component (i.e. the audio) of the media stream being played back by the TV decoder 201 either on its own or in addition to the sound being played back by the TV set 204.

In another embodiment that is not shown, the TV set 204 is connected to the TV decoder 201 via an HDMI (or SCART) cable and the sound bar 205 is also connected directly to the TV decoder 201 via audio outlets (e.g. of the RCA/Cinch type).

A telephone handset 203 is shown that is connected—typically using DECT wireless technology—to the home gateway 100, 202, and more precisely to its DECT module 102. The telephone handset 203 is generally held by a support that serves to recharge it. Depending on circumstances, the telephone handset 203 may be situated in the same room as the TV set 204 and the sound bar 205. As a general rule, the telephone handset corresponds to a telephone or other equipment that is said to be “fixed”, and for home use.

In an alternative embodiment of the present invention, the telephone handset 203 corresponds to a piece of electronic equipment, e.g. mobile equipment of the tablet or smartphone type, that has a suitable application installed and running thereon. Under such circumstances, the telephone handset 203 can be connected to the home gateway 100, 202 via WiFi or Bluetooth technology, for example, it being possible for the DECT module 101 not to be used. By way of example, such an application may be downloaded from an application server such as Google Play™. This enables a tablet or a cell phone of GMS/UMTS type to be transformed into a voice telephone using the telephone line made available via the home gateway 100, 202.

FIG. 2B shows a system in accordance with an alternative embodiment, in which the functions of the home gateway 100 and of the TV decoder 201 are combined in a single piece of equipment 207. The above description for FIG. 2A of the telephone handset 203, the sound bar 205, the connection to the Internet 206, and to the TV set 204, remains valid for the system shown in FIG. 2B.

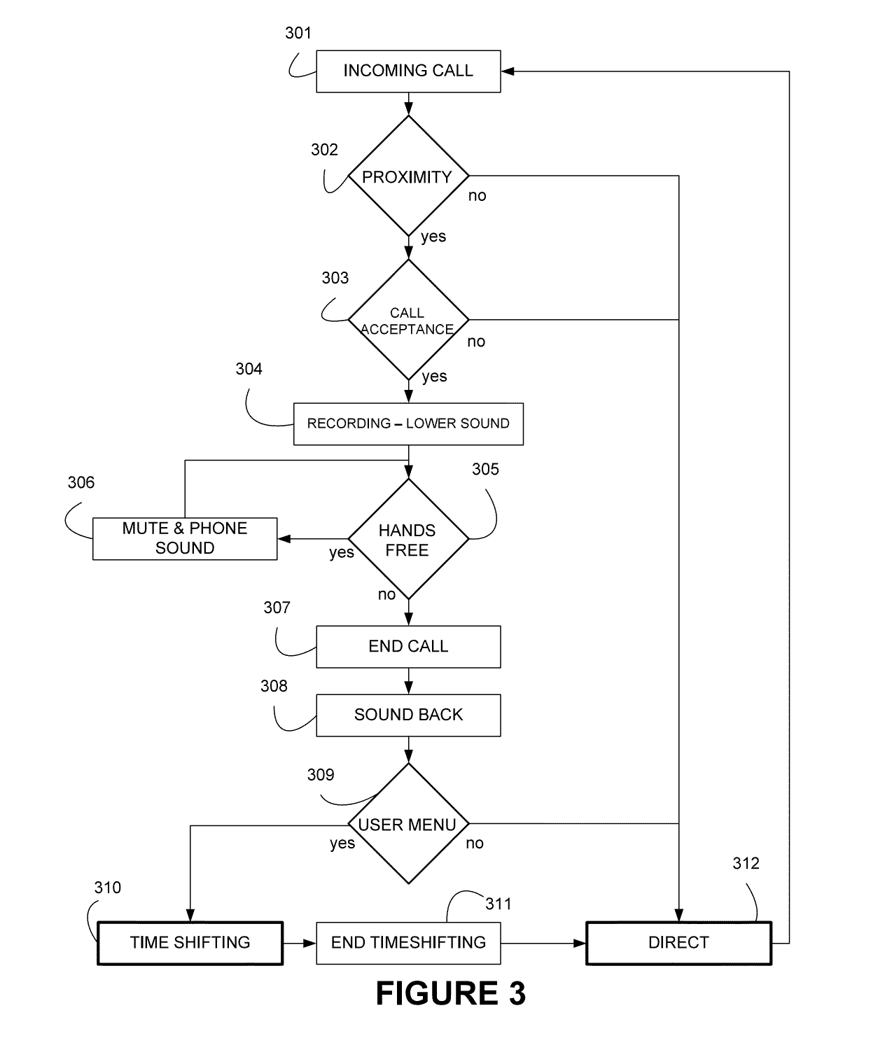

FIG. 3 is a flow chart showing the performance of a method of controlling the playback by a TV decoder module 201 of a media stream on at least one device 204, 205 connected to the TV decoder 201, as performed by computer means including a home gateway 202 connected to the TV decoder 201 and including a telephone control module 102, which telephone control module controls at least one telephone handset 203 in an embodiment of the invention.

By way of example, the system performing the method as described below is the system shown in FIG. 2A, comprising a home gateway 100, 202, that is connected to a telephone handset 203, and a TV decoder 201, the TV decoder 201 being connected to a TV set 204 and to a sound bar 205.

The starting situation—corresponding to step 312—is that of one or more users watching a program or content via the TV decoder 201. In other words, the users have used the TV decoder 201 to select a media stream corresponding to the content, which stream is being played back on the TV set 204 for its video component, and on the sound bar 205 for its audio component. By way of example, the media stream may correspond to an IP TV program or to a VOD content that is transmitted from the IAP's network via the home gateway 100, 202 to the TV decoder 201. This media stream thus has a video component and an audio component. The same method is applicable to a media stream that has only an audio component or only a video component, such as for example an Internet-broadcast radio stream. It should be observed that the media stream may come from any source other than the IAP's own network and need not necessarily pass through the home gateway 100. The same method is applicable with any media stream received by the TV decoder 201 and played back on at least one device.

In a first step 301, the home gateway 100, 202 detects the arrival of an incoming telephone call. More precisely, this telephone call is received by the DECT module 102 that is connected to the telephone handset 203. Depending on the embodiment, the telephone call may be presented at once to the telephone handset 203, or there may be a wait for a certain length of time in order to perform the proximity detection step 302 under the best possible conditions. A “certain length of time” should be understood to mean a few seconds. The call is said to be “presented”, e.g. when performing the actions that cause the telephone handset 203 to ring in order to inform users that there is an incoming call.

In a step 302, the home gateway 100, 202 determines that there is proximity between the telephone handset 203 and a device 204, 205 connected to the TV decoder 201. Determining whether there is proximity between the telephone handset 203 and the device 204, 205 connected to the TV decoder 201 comprises the steps of receiving a first audio signal picked up by a microphone of the telephone handset 203, of receiving a second audio signal, the second audio signal corresponding to an audio signal associated with the media stream being played back on at least one device 204, 205, and determining that the first and second audio signals correspond, which correspondence indicates that there is proximity between the telephone handset 203 and at least one device 204, 205.

In other words, and depending on the embodiment, the home gateway 100, 202 activates the microphone of the telephone handset 203 via the DECT module 102 and picks up a first audio signal. This audio signal thus corresponds to the ambient noise in the vicinity of the telephone handset 203. The principle is thus to compare this ambient noise with the audio component of the media stream being disseminated, i.e. as played back by the TV decoder 201, e.g. via the sound bar 205 (or via the TV set 204 if the sound bar is not used). For this purpose, the home gateway 100, 202 can send a request to the TV decoder 201 to send a second audio signal, which second audio signal corresponds to an audio signal associated with the media stream, i.e. its audio component as played back on at least one device, and in response to the request it can receive in return at least one second message comprising the second audio signal. Thus, the home gateway 100, 202 has an audio signal corresponding to the audio component of the media stream being played back, in other words of the sound of the disseminated program. The home gateway 100, 202 can then determine whether there is any correspondence between the first audio signal and the second audio signal, i.e. between the ambient noise picked up by the microphone of the telephone handset 203 and the sound of the program being disseminated by the TV decoder 201 either via the TV set 204 or via the sound bar 205. This is based on the principle that if the telephone handset 203 is in the proximity of the TV set 204 or the sound bar 205, (depending on which device is being used for playing back the sound of the disseminated program), then that sound should form an integral portion of the ambient noise picked up by the microphone of the telephone handset 203. It can thus be understood that if there is correspondence, that indicates that the telephone handset is in the proximity of the TV set 204 or of the sound bar 205, and more generally that the telephone handset is very probably situated in the same room as the users viewing the content disseminated via the TV decoder 201. The audio signals may correspond respectively to a few seconds of the picked up ambient noise and to the sound component of the media stream. In an additional embodiment, the first or the second audio signal is an audio stream. Advantageously, under the control of the DECT module 102, the microphone of the telephone handset 203 can pick up the ambient noise continuously. Thus, in general manner, the home gateway 100, 202 can determine whether there is proximity at any time, e.g. by sending a request to the TV decoder 201 to be provided with a second audio signal—either a sample or a continuous audio stream—that corresponds to the audio component of the media stream being played back on the TV set 204 or the sound bar 205, and then by comparing the two audio signals. The terms determining correspondence or comparison between two audio signals should be understood to cover any method making it possible to determine that the two audio signals are similar. By way of example, this may be a method relying on calculating an audio signature for the two signals and comparing the two signatures. The term “audio signature” is used to mean a result obtained by applying a filtering or processing method to an audio signal.

Thus, if there is no correspondence—or not sufficient correspondence—between the two audio signals, the home gateway 100, 202 determines that there is no proximity and the following step is the step 312. A priori, this corresponds to a situation in which the telephone handset is not in the proximity of the users viewing the TV set 204 or listening to the sound bar 205 (or both). Under such circumstances, no particular action needs to be taken, the telephone handset rings normally, and the users continue to benefit from the content being disseminated. If the call is accepted, it is assumed that the telephone conversation will take place far enough away from the TV set 204 or the sound bar 205 to ensure the conversation is not disturbed by the sound being disseminated.

Otherwise, if there is correspondence between the two audio signals, and thus if it is determined that there is proximity, it can be assumed that the situation is such that a call accepted on the telephone handset 203, and thus the resulting telephone conversation, will be disturbed by the content being disseminated, and more particularly by the sound being disseminated.

Thus, in a step 303, the system reacts differently depending on whether or not the incoming call is accepted. If the call is not accepted, then no particular action is taken, as when proximity is not determined, and the users continue to benefit from their program normally as described above with reference to step 312. If the telephone call is accepted, then particular actions are performed by the home gateway 100, 202 in a step 304.

In an alternative implementation, call acceptance is not taken into consideration, i.e. the test corresponding to step 303, i.e. corresponding to detecting that the telephone call has been accepted, is not performed. In other words, where there is proximity, if the DECT module 102 receives a telephone call, then the actions corresponding to step 304 are performed.

In step 304, when there is proximity and a telephone call is received or is accepted by a user—depending on the implementation—the home gateway 100, 202 sends a first message to the TV decoder 201, which first message contains an instruction to record the media stream that is being disseminated. Thus, the home gateway 100, 202 sends an instruction to the TV decoder 201 to start recording the content that is being disseminated. In an additional implementation, the first message also contains an instruction to change the sound volume of the media stream being played back on at least one connected device. In other words, as well as causing the TV decoder 201 to start recording the media stream, the home gateway 100, 202 can also send an instruction to the TV decoder 201 to control the sound, and more advantageously an instruction to lower the sound being played back in order to reduce disturbance; with this being done either to make it easier to hear the telephone handset 203 ring, or else to enable a user who has answered the call to hear the caller better.

Throughout the duration of the call, and in an additional implementation of the invention, the user may desire to use a “hands-free” mode. This is usually done by pressing on a possibly dedicated button on the telephone handset 203. If the user activates hands-free mode, then the home gateway 100, 202 sends an instruction to the TV decoder to switch off the sound of the media stream that is being played back. Simultaneously, the home gateway 100, 202 sends the audio stream corresponding to the audio stream coming from the caller to the TV decoder 201 for playing back. The TV decoder 201 thus plays back the audio signal coming from the caller instead of the audio component of the media stream. This makes it possible to benefit from the hands-free function by using the loudspeakers of the TV set 204 or of the sound bar 205.

In a step 307, when the user or the caller terminates the call, or more generally when the telephone call comes to an end for any other reason, the home gateway 100, 202 sends a third message to the TV decoder 201, the third message including an instruction to present a predefined user interface on a playback device, the user interface including a first user-selectable option of stopping the recording of the media stream and a second user-selectable option of playing back the recorded media stream with recording of the media stream then continuing. In other words, at the end of the call, the home gateway 100, 202 sends an instruction to the TV decoder 201 to display a menu on the TV set 204 (or on any other device that can display a graphics interface of the TV decoder 201), which menu gives the user the possibility of selecting between a first option of continuing to view the media stream live (or to listen to it if it is an audio only stream)—the recording then being stopped—and a second option of restarting media stream viewing (or listening) from the time at which the telephone call was received or accepted, i.e. as from when recording was started in step 304. Under such circumstances, the media stream continues to be recorded, with the TV decoder 201 playing back the recorded media stream. In other words, in the second option, “time shifted”, or “deferred”, viewing or listening of the media stream is started, with users viewing or listening to a media stream that has been shifted in time by the duration of the telephone conversation.

In an additional implementation, represented by step 308, the fourth message sent by the home gateway 100, 202 corresponds to an instruction to control the sound volume of the media stream played back on the connected device. In other words, at the end of the telephone call, the home gateway 100, 202 can request the TV decoder 201 to restore sound to the level it had before being automatically lowered in step 304. This option may be deactivated if, since step 304, the TV decoder 201 has already received a user command requesting the sound to be turned up, i.e. if the user has already turned up the sound during the telephone call. In an additional implementation of the invention, if the sound was only turned down during the call, it is then returned to the level it had before the call at the end of the telephone call. Alternatively, the sound is returned to its original level only if its level was not modified during the call.

Depending on the selection made by the user, represented by step 309, the TV decoder 201 thus goes into “normal” mode—step 312—or into “time shifting” mode—step 310.

Thus, if so desired, this method makes it possible for a user who has answered the telephone call to return to the program at the moment when the user was disturbed by the call (either on receiving the call or on accepting the call), while still reducing the disturbance caused by the sound of the disseminated program. In the same manner, users viewing a program with the user who accepted the telephone call can nevertheless continue to benefit from the program since the program is not interrupted nor is it paused, but is merely recorded during the duration of the telephone call. At the end of the call, a choice is made available between continuing to view the media stream “live” or else to view it in time shifted mode. Likewise, the sound level that was automatically lowered on receiving or accepting the call is returned to its previous level—as it was before receiving or accepting the call—, or to some predetermined level.

When time shifting comes to an end, in a step 311, the system returns to its normal state corresponding to the state of step 312.

In the above description, the control method is performed by a home gateway that controls a telephone handset such as a mobile or fixed terminal or piece of equipment. In this embodiment, the home gateway can be considered as being a piece of electronic equipment that is distinct from the telephone handset.

In more general manner, the control method may also be performed by a piece of electronic equipment such as a tablet or a smartphone controlling the telephone handset.

This may apply in particular when the piece of electronic equipment is a tablet, including a telephone control module such as a voice application such as Skype™, Viber™, or Whatsapp™, enabling a telephone handset such as one or more smartphones to be controlled. In this additional embodiment, the piece of electronic equipment, specifically the tablet, performs the same role as the home gateway, i.e. when the VoIP voice application receives a telephone call:
it determines whether there is proximity between the telephone handset, namely the smartphone, and a device connected to the TV decoder; and
if there is proximity, it sends a first message to the TV decoder, the first message including an instruction to record the media stream that is being played back. In this embodiment, the tablet may be connected to the TV decoder either via a local network of the WiFi type, or via a cell phone network of the 4G type, or similar.

In an additional embodiment, the electronic equipment performing the control method may comprise or coincide with the mobile equipment. This applies for example to a smartphone or other mobile equipment acting both as the home gateway in the present method and acting as the telephone handset. The electronic equipment, namely the smartphone, on receiving a telephone call via the VoIP application:
determines whether there is proximity between the telephone handset and a device connected to the TV decoder, i.e. whether it is itself in the proximity of the TV decoder; and
if there is proximity, it sends a first message to the TV decoder, the first message including an instruction to record the media stream being played back.

1. A method comprising:
controlling, using electronic equipment, playback by a TV decoder module of a media stream on at least one device connected to the TV decoder, the electronic equipment being connected to the TV decoder and including a telephone control module, which telephone control module controls at least one telephone handset, wherein, in the event of the telephone control module receiving a telephone call, the electronic equipment:
determines whether there is proximity between the telephone handset and a device connected to the TV decoder; and
if there is proximity, sends a first message to the TV decoder, the first message including an instruction to record the media stream being played back.

2. The method according to claim 1, the electronic equipment comprising a home gateway using the telephone control module to control the telephone handset that is distinct from said electronic equipment.

3. The method according to claim 1, the electronic equipment comprising the telephone handset.

4. The method according to claim 1, the first message being sent to a user accepting the telephone call.

5. The method according to claim 1, the first message including an instruction to control the sound volume of the media stream played back on at least one connected device.

6. The method according to claim 1, the determination of proximity between the telephone handset and the device connected to the TV decoder comprising the following steps:
receiving a first audio signal picked up by a microphone of the telephone handset;
receiving a second audio signal, the second audio signal corresponding to an audio signal associated with the media stream played back on at least one device; and
determining whether there is correspondence between the first and second audio signals, with correspondence indicating that there is proximity.

7. The method according to claim 6, the first or second audio signal being an audio stream.

8. The method according to claim 5, reception of the second audio signal comprising the following steps:
sending a request to the TV decoder to send a second audio signal, the second audio signal corresponding to an audio signal associated with the media stream being played back on at least one device; and
receiving in response to the request at least one second message comprising the second audio signal.

9. The method according to claim 1, the method further including a subsequent step when the telephone call ends:
sending a third message to the TV decoder, the third message including an instruction to present a predefined user interface on a playback device, the user interface comprising:
a first user-selectable option of stopping the recording of the media stream; and
a second user-selectable option of playing back the recorded media stream, with recording of the media stream continuing.

10. The method according to claim 9, the fourth message including an instruction to control the sound volume of the media stream being played back on the connected device.

11. A piece of electronic equipment connected to a TV decoder, the TV decoder playing back a media stream on at least one device that is connected thereto, the electronic equipment comprising:
a telephone control module, which controls at least one telephone handset,
a module configured:
determine whether there is proximity between the telephone handset and a device connected to the TV decoder; and
control playback and recording of the media stream by the TV decoder as a function of whether proximity is determined.

12. A non-transitory computer-readable medium comprising a computer program stored thereon comprising instructions for performing a method of controlling playback by a TV decoder module of a media stream on at least one device connected to the TV decoder, when the program is executed by at least one processor of a home gateway, a telephone control module being included in the home gateway or separate from the home gateway, wherein the instructions comprise:
instructions that configure the home gateway to control the playback by the TV decoder, which is connected to the home gateway, wherein, in the event of the telephone control module receiving a telephone call, the home gateway:
determines whether there is proximity between the telephone handset and a device connected to the TV decoder; and
if there is proximity, sends a first message to the TV decoder, the first message including an instruction to record the media stream being played back.
